(19) United States
(12) Patent Application Publication
(10) Pub. No.: US 2013/0278412 A1
(43) Pub. Date: Oct. 24, 2013

(54) NETWORKED SYSTEM AND METHODS FOR DETECTION OF HAZARDOUS CONDITIONS

(71) Applicants: William Kelly, Mesquite, TX (US); Leonard Urbanovsky, Tomball, TX (US); Daniel P. Alpha, JR., The Woodlands, TX (US)

(72) Inventors: William Kelly, Mesquite, TX (US); Leonard Urbanovsky, Tomball, TX (US); Daniel P. Alpha, JR., The Woodlands, TX (US)

(73) Assignee: Detcon, Inc., The Woodlands, TX (US)

(21) Appl. No.: 13/452,310

(22) Filed: Apr. 20, 2012

(51) Int. Cl. G08B 17/10; G08B 1/08; G08B 21/00

(52) U.S. Cl. 340/539.1; 340/540; 340/632

(57) ABSTRACT

In an alarm network involving a set of intercommunicating alarm nodes, departure from the network of the master node—due to failure, in the course of system reconfiguration, or for some other reason—is detected by the remaining nodes in the network, which cooperate to elect or designate a new master node autonomously.

### FIELD OF THE INVENTION

The present application relates to detection of alarm conditions, and more particuarly to distributed systems for detecting and reporting the location of a hazardous or other reportable event, such as a gas leak.

### BACKGROUND

Devices for detecting a hazard, such as the presence of gas or smoke in dangerous concentrations, are well-known and widespread. For example, smoke or carbon-monoxide detectors are today found in most homes. While simple installations involve judicious placement of individual units in different locations within a dwelling, more sophisticated systems may be tied into an alarm system and identify the location of the sensed hazardous condition.

Still greater sophistication is needed for industrial applications, which may be spread out over a much wider area and involve many more hazards. The tolerable level of a potentially toxic or flammable gas, for example, may depend on the degree of ventilation, the composition of the gas, and the likelihood of human traffic—factors that may vary significantly across an installation and over time. Thus, industrial systems configured to detect even a single type of hazard may involve a variety of detection technologies; for example, a gas-detection system may include electrochemical sensors for toxic gases, solid-state metal oxide silicon sensors for hydrogen sulfide, catalytic beads for combustible gases and infrared detectors for combustible hydrocarbons. Moreover, the size of an industrial installation often makes point-to-point wiring among devices impractical, necessitating wireless communication among detection devices and, typically, with a central controller.

Even conventional wireless systems can be difficult to maintain, particularly for sites that expand or undergo reconfiguration. If each sensor device must independently communicate with a central controller, for example, the deployment range will be limited by the transmission power of the individual devices. Sudden increases in coverage needs—e.g., when a new wing is added to a building or an existing facility is re-outfitted for more hazardous operations—can quickly outgrow a fixed system's expansion capacity, necessitating expensive component replacement and/or addition of separate, discrete sensor networks. In the latter case, facility-wide monitoring is sacrified unless the separate networks can somehow be tied together.

One way of avoiding such limitations is through use of a scalable network architecture, such as a mesh or ad hoc network. In such systems, any sensor device or “node” can communicate with any other device, either directly or through intermediate nodes. When a new sensor is added to the system, it is recognized by every other device and by a central controller (if the system includes one), and the network is effectively expanded merely as a result of this recognition; the new device can communicate with every other device, and the central controller can interrogate it or respond to alarm signals that it sends. Similarly, loss of a device—due either to malfunction or deliberate removal from the network—does not affect overall network operation; when the central controller recognizes that a device is no longer present, it simply deletes that device from the routing table.

In some network topologies, the central controller is eliminated by designating one of the sensors as a “master” and the rest as “slaves.” The master device typically has system-wide supervisory responsibilities that are more efficiently handled by a single node than on a distributed basis, i.e., by all nodes. A master device may be specially configured or simply a designated one of many identical devices, any of which is equipped to act as master if triggered to do so. This may involve higher per-device costs, since all nodes must be able to perform network oversight functions, but this cost can be minimized by decoupling monitoring from display and interface functions. Not every node, in other words, needs the ability to interact with a human operator. Instead, a display node—i.e., a device such as a laptop or tablet—can be configured to enter the network on an ad hoc basis as a node and to interact over the network with the detection nodes. In this way, an operator can enter the network via the display node and query selected sensors or view alarm conditions, and exit the network without disruption.

Although highly extensible and flexible, even a mesh network architecture can be vulnerable to disruption if the master node malfunctions. Typically the system administrator or an operator directly selects the master node, which provides humans with a gateway into the network. If the master node fails, the entire network may require re-initialization as a new master node is designated and its identity propagated to the other nodes.

### SUMMARY

In accordance with embodiments of the present invention, departure from the network of the master node—due to failure, in the course of system reconfiguration, or for some other reason is detected by the remaining nodes in the network, which cooperate to elect or designate a new master node autonomously. In one approach, each node has a unique assigned identifier that is propagated to every other node, so that each node maintains a record of the devices currently connected to the network. The identifiers have (or map to) a hierarchical sequence; most simply, each identifier is a different number, e.g., in the manner of a serial number or MAC address. If the master node leaves the network, the remaining node with the hierarchically highest identifier (e.g., the in the case of a numeric identifier, the one with the greatest numeric value) becomes the new master node. In a typical implementation, an election process occurs where each node broadcasts its identifier, and the highest priority wins the election and assumes the role of master node. Alternatively, all nodes can store the identifiers of all other nodes and thereby recognize which node will assume the master role, obviating the need for arbitration or other election procedures. In any case, the new master node may broadcast a message to all other nodes confirming its assumption of the master role. In this way the network may remain fully ad hoc, adjusting to entry and exit of nodes (even the master node) without the need for external involvement. It should be stressed, however, that the present invention is applicable both to wireless (e.g., ad hoc) networks as well as to wired networks.

Accordingly, in a first aspect, the invention relates to a safety sensor and communication device for operation in conjunction with other safety sensor and communication devices in a network configuration. In various embodiments, the device comprises a sensor for sensing a hazardous condition; a transceiver for communicating over the network; a controller operatively connected to the sensor and the transceiver; a memory for storing (i) a unique device identifier and (ii) an alarm state having a value based on a state of the sensor; and a database for storing network information. The controller is configured to (i) operate the device in a slave mode if a master device is detected on the network via the transceiver, (ii) detect departure of a master device from the network and cooperate with other devices on the network to designate a new master device, and (iii) operate the device in a master mode if the device is designated as the master device on the network. Moreover, when operating in the master mode, the controller is configured to communicate with other devices on the network and obtain sensor data therefrom, and to maintain the sensor data in the database.

When operating in the master mode, the controller may be further configured to issue an alarm signal in response to sensing of the hazardous condition by one of the devices on the network. As will be seen, however, responsibility for alarm triggering need not be limited to the master device. A controller in accordance with the invention may be configured to (i) recognize a device as the new master device if the device's unique identifier is hierarchically superior to the other identifiers stored in the database and (ii) broadcast to the network, via the transceiver, designation of the device as the new master device. In the slave mode, a controller may operate to (i) store a state of the sensor in the memory and (ii) respond to queries from the master device via the transceiver.

In various implementations, a controller operating in the master mode is configured to query, via the transceiver, the memory of each other device connected to the network to determine the sensor state thereof and to issue an alarm signal if an alarm condition is detected. In the master or slave mode, the controller may be configured to detect and communicate with, via the transceiver, a display device connected to the network. The sensor may be configured to sense virtually any environmental or process conditions such as gas level, pressure, temperature, flow, fluid level, etc., or a security condition, e.g., access breaches, perimeter activity, etc. The transceiver may be a wireless transceiver or a wired network interface.

In another aspect, the invention relates to a linked network of safety sensors. In wireless implementations, the system may comprise a plurality of safety-sensor devices each comprising a sensor for sensing a hazardous condition; a wireless transceiver; and a controller operatively connected to the sensor and the transceiver, the devices communicating wirelessly in a network configuration. Each device is configured to sense departure of the master device from the network and, in response, to cooperate to designate as a new master device one of the devices still connected to the network. The network may also include at least one display connectable to the network. When connected, the display may receive data from all devices or only from a device operating as a master device, in which case all devices other than the master device operate as slave devices subject to query by the master device.

In various embodiments, the network configuration is a mesh network in which each device can communicate with every other connected device. Each of the slave devices may be configured to register an alarm condition sensed by the device's sensor, but in some configurations only the master device is configured to issue an alarm signal. In other configurations any device may issue or cause issuance of an alarm signal. An alarm condition may comprise one or more of (i) a visual alarm, (ii) an audible alarm or (iii) an electronic communication with an operator, and the alarm may be visual and/or audible, and may be communicated via a device, via a display, or via a stand-alone alarm unit. The display may obtain sensor data from at least some of the devices, either directly or via the master device.

In some implementations each device is associated with a unique identifier, the device identifiers form a hierarchy, and the device associated with the identifier highest in the hierarchy is recognized as the new master device by the other devices. Each slave device may store sensor data locally and may communicate directly only with the master device. All device identifiers may be stored on each of the devices, or, alternatively, all device identifiers may be stored only on the master device.

The display may perform various functions. For example, a display may be operable to change device settings of any of the devices and/or may be operable to alter programming of any of the devices.

In still another aspect, the invention pertains to a method of sensing and communicating among a plurality of safety sensor devices in a network configuration, where each device includes a sensor for sensing a hazardous condition. In various embodiments, the method comprises the steps of detecting, at each device, whether the hazardous condition is present; operating the devices to cooperatively designate one of the devices as a master device, the other devices operating as slave devices; causing the master device to (i) determine whether its sensor detects the hazardous condition, (ii) query each slave device for the hazardous condition, and (iii) monitor issuance of an alarm signal if the hazardous condition is detected at any device; and sensing, by each device, departure of the master device from the network and, in response, cooperating with the other devices in an election procedure to designate as a new master device one of the devices connected to the network. The network configuration may be, for example, a mesh network in which each device can communicate with every other device.

The alarm signal may be a visual alarm, an audible alarm, an electronic communication with an operator, or some combination. The method may also include connecting at least one display to the network. The display may obtain sensor data from at least some of the devices or, alternatively, only from the master device. In some implementations the alarm signal is communicated via the display.

In various embodiments each device has a unique identifier, the device identifiers form a hierarchy, and the election procedure comprises recognizing, by all of the devices, the device having the identifier highest in the hierarchy as the new master device. When a new device is added to the network it may in some cases be determined, without an election procedure, whether the added device has an identifier higher than the master device. If, for example, the added device has an identifier higher than the master device, the master device thereafter operates as a slave device and the added device operates as the master device. Alternatively, when new device is added to the network, it may operate as a slave device at least until the master device departs the network. The respective roles of master and slave may vary depending on the implementation; in some embodiments, for example, each slave device stores sensor data locally and communicates directly only with the master device.

### BRIEF DESCRIPTION OF THE DRAWINGS

Embodiments of the invention are better understood with reference to the following drawings. The elements of the drawings are not necessarily to scale relative to each other.

FIG. 1 schematically depicts a network of hazard sensors in accordance with embodiments of the invention.

FIG. 2 illustrates the components of a representative hazard-sensing device in accordance with embodiments of the invention.

FIG. 3 shows the organization of a representative database maintained at least by a master device in accordance with embodiments of the invention.

FIG. 4 is a flow chart depicting a procedure for electing a new master device in accordance with embodiments of the invention.

### DETAILED DESCRIPTION

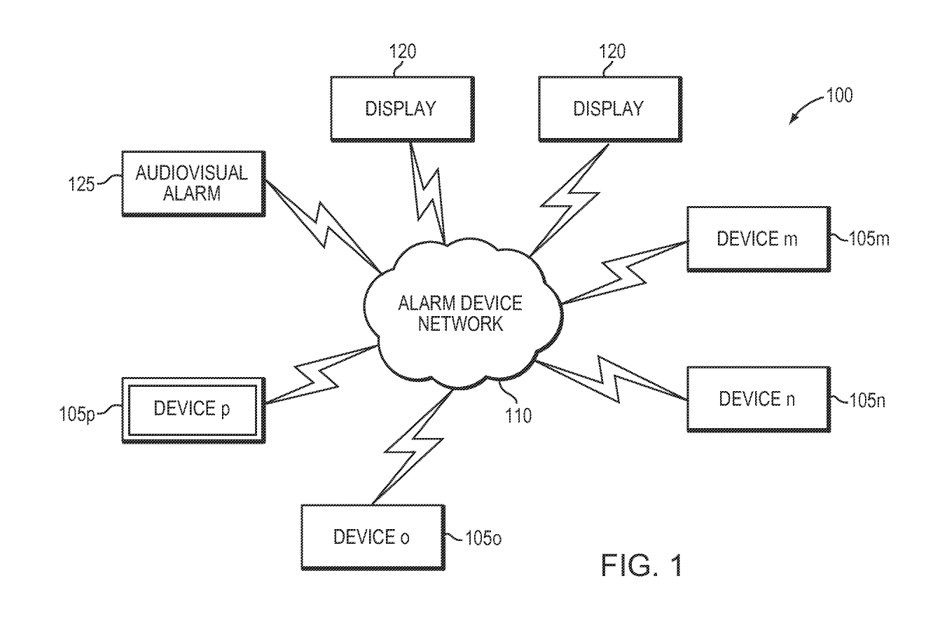

Refer first to FIG. 1, which illustrates the overall organization of a device network 100 in accordance with the invention. A plurality of peer devices 105ₘ, 105ₙ, 105ₒ, 105ₚ intercommunicate wirelessly as nodes of an ad hoc or mesh network 110. In fact, the network 110 is really an abstraction that does not exist independently of the devices 105; instead, the network 105 represents a shared communication protocol according to which each of the devices 105 communicates with the others in an organized fashion that allows each device to send and receive messages to and from any other device. If all devices are within range of each other, they may send messages (which may be in the form of data packets) over a fixed frequency using a local area network (e.g., a ring topology) or other suitable network arrangement in which each device “multicasts” messages to all other devices in accordance with a communication protocol that allocates network time among the devices. Typically, however, a more advanced routing protocol is used to permit messages to reach all devices even though some are out of radio range of the message-originating device; each device “knows” which devices are within its range and propagates received messages to neighboring devices in accordance with the protocol. Numerous schemes for routing messages across mesh networks are known and may be employed herein; these include AODV, BATMAN, Babel, DNVR, DSDV, DSR, HWMP, TORA and the 802.11s standards being developed by the IEEE.

Each device 105 is equipped to detect a hazardous or other alarm condition. One or more display units 120 may be connected to the network 110 (in the sense of being able to communicate with other network nodes, i.e., intercommunicating devices 105, 120) to allow an operator to query the state of any device. A display unit 120 may be a laptop, tablet or other device with suitable computational and communication capabilities. As described below, each device 105 maintains information at least about its own identity, state and settings; the master device maintains the same information about all other devices currently communicating via the network 110. In some implementations, however, all devices have a database storing information about every currently connected device; in this way any device 105 may assume the role of master node immediately and at any time. In FIG. 1, the device 105ₚ is the current master device.

At least one alarm unit 125 is also connected to the network 110. The alarm unit 125 may provide an audible alarm, a visual alarm, or an alarm having both audio and visual components. Alternatively or in addition, alarm unit 125 may alert an operator to an alarm condition via cellphone, e-mail or other form of wirelessly transmitted alert. As shown, the alarm unit is a separate station connected to the network, but in some implementations, one or more of the devices 105 and/or one or more of the displays 120 have an alarm unit included therein. A system may, for example include device-borne alarms in some or all of the devices 125, but may also have one or more stand-alone alarm units 125 to provide alerts in critical management areas not proximate to a sensing device 105. As explained below, devices 105 can be configured in various ways with respect to activation of an internal or external alarm unit; for example, a particular device 105 may be configured to activate only its own internal alarm, or all external alarm stations 125 within the device's zone (e.g., within a wireless transmission zone), or all external alarm stations 125 system-wide. In addition, while in some implementations any device 105 can activate an alarm, in other implementations only a master device can activate an external alarm 125.

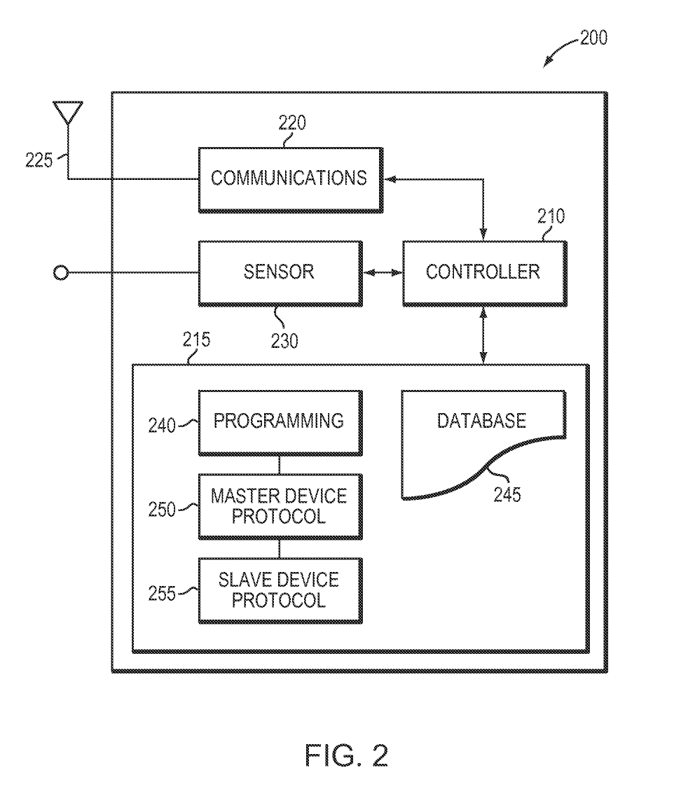

FIG. 2 shows a sensor device 200 in greater detail. The various components are illustrated conceptually to indicate their roles and interaction, but this is for explanatory purposes only; it should be understood that other computational configurations (e.g., using a bidirectional bus to facilitate communication among components) are within the scope of the invention. The device 200 includes a microcontroller or microprocessor 210, which executes program instructions stored in a system memory 215. The device 200 communicates wirelessly via a mesh network with other similar devices by means of a conventional radio communication module 220, which is connected to an antenna 225. A sensor 230, under the control of microcontroller 210, detects hazardous conditions.

System memory is typically composed of a combination of volatile RAM for temporary storage and processing, and non-volatile memory (Flash, read-only memory (“ROM”), programmable read-only memory (“PROM”), etc.) that contains permanent aspects of the device's operating instructions. A general programming block contains instructions executable by microcontroller 210 to perform the basic operations of the device 200, including operation of sensor 230, processing signals therefrom and storing the sensor readings in a database 245. A master device protocol 250 contains instructions for performing the functions associated with a master device, so that the device 200 can assume this rol if so designated or elected. A slave device protocol 255 contains instructions for performing the functions associated with a slave device. The slave protocol 255 is the default protocol executed by microcontroller 210. These functions are described in greater detail below.

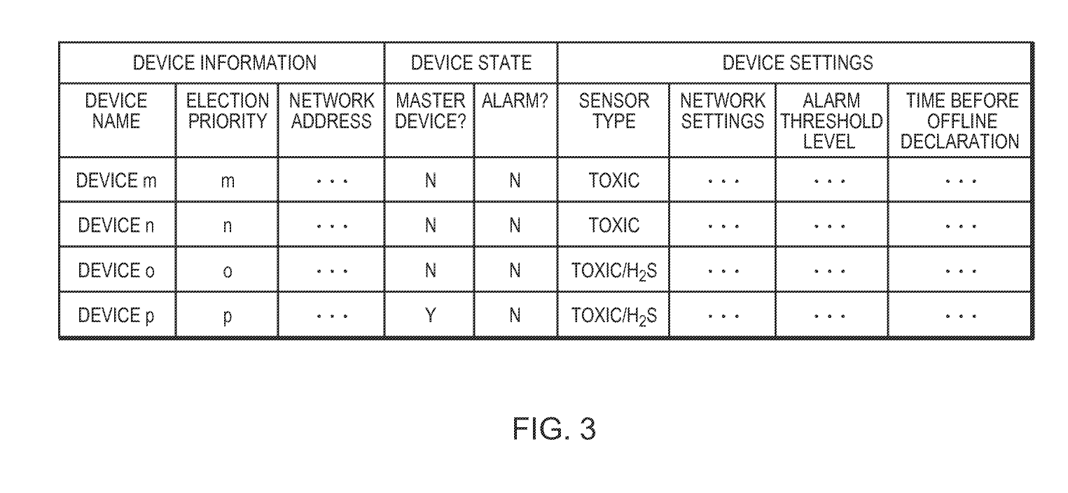

The database 245 may be a memory partition or a separate memory device, and as shown in FIG. 3, it includes fields for information falling within at least three categories: general information about the device 200; device state information; and device settings information. The master device maintains this information for all devices currently connected to the network. In some implementations, each slave device 105ₘ, 105ₘ 105ₒ maintains this information only for itself and provides it to the master device 105ₚ upon query—e.g., when a new device assumes the role of master, and periodically as the master polls slave devices to update the field values. But more typically, all devices maintain complete databases that include entries for all network-connected devices in order to facilitate immediate assumption of the role of master device; in a network of any size, too much time would be required for the new master to obtain the necessary data from every other device.

Device information may include the device name, election priority, and network (e.g., MAC or higher-level) address. In some implementations, these can reduce to a single designation, e.g., a unique numeric address. Although each device in the network may be identical, the election priority is used to establish which device will become the new master when the current master device leaves the network. Thus, in FIG. 3 each of the variables m, n, o, p correspond to a numeric value, and if p>o>n>m, then device p is the master device. Numeric identifiers are easily compared to determine the highest value among devices connected to the network, but any hierarchical scheme that uniquely places each device within a hierarchy may be used. Other device fields (not shown in FIG. 3) may include, for example, RF channel, alarm zone covered by the device, zone mapping information.

The illustrated device state fields specify whether the device is the master device and whether an alarm condition has been detected; for example, with reference to FIG. 2, when microcontroller 210 detects a sensor reading in excess of the alarm threshold level set for the device, it may store the value in the alarm field. In some embodiments, only the master reports alarm conditions on a system-wide basis to an operator. In such implementations, slave devices may simply store the alarm condition and provide it to the master device upon interrogation, or alternatively, broadcast the alarm locally; the master device reports the alarm condition (as described below) for itself and for any other device in which an alarm condition has been detected by query over the network. The alarm condition field may be a simple yes/no flag, or a one of several risk levels corresponding to different ranges of sensor values, or the absolute value of the sensor reading. In other implementations, every device reports alarm conditions that it senses, and these are propagated among all nodes and to connected display devices, as well as to alert stations that provide visual or audio indications of the alarm condition.

The device settings fields may include the sensor type, network settings, the alarm threshold level, and a maximum time between queries from the master which, if exceeded, is treated as departure of the current master device from the network. The alarm threshold level corresponds programmed value of a sensed condition that, for the particular device given its placement, qualifies as an alarm condition. If a device has multiple sensors, then multiple corresponding thresholds (i.e., database fields) are provided. As noted earlier, the alarm level may depend on the nature of the deployment as well as the identity of the sensed condition. Other device settings that may be represented in database 245 include whether a battery has been installed and is functional, radio settings, etc.

It should be stressed that, although the database is illustrated in tabular form, the actual storage format and arrangement are not critical; what is important is the data itself and its accessibility. Furthermore, the illustrated data categories and fields are representative only; some implementations may contain more, and some fewer, categories and fields.

Microcontroller 210 and communication module 220 (as well as elements of memory 215) may be, for example, a SYNAPSE RF Engine 100 or 200 (Synapse Wireless, Inc., Huntsville, Ala.)(but more generally, microcontroller 210 may be any suitable processing unit capable of executing commands and instructions and implementing the functions described herein, e.g., a programmed microprocessor, a peripheral integrated circuit element, an ASIC (application-specific integrated circuit), a programmable logic device such as an FPGA (field-programmable gate array), a PLD (programmable logic device), a PLA (programmable logic array), etc. Communication module 220 may be a transceiver operating, for example, at a frequency of 2.4 GHz and capable of transmitting signal data from 4-20 mA DC or serial MODBUS inputs. The communication module may utilize direct-sequence spread-spectrum communication. Moreover, in various implementations, each module 220 is capable of functioning as a router and repeater for all other modules 220 (i.e., other devices) in the network. This allows devices 200 to communication with other devices beyond their wireless range, or which are blocked by RF line-of-sight obstacles, by “hopping” through neighboring devices.

Sensor 230 may be any sensor for detecting a hazardous or other alarm condition. In some embodiments, the sensor 230 is a gas detector. For example, a sensor 230 may include one or more of (i) an electrochemical sensor for toxic gases, (ii) a solid-state metal oxide silicon sensor for hydrogen sulfide, (iii) catalytic beads for combustible gases and/or (iv) infrared detectors for combustible hydrocarbons. More generally, numerous known sensor technologies may be used for sensor 230. For example, combustible gas indicators (CGIs) may monitor catalytic combustion and thermal conductivity of a gas sample, allowing them to sense virtually all combustible gases. CGIs, however, are low-sensitivity devices that are generally unable to detect gas mixtures much below the lower combustible concentration limit. A flame ionization detector (FID) measures the ionic concentration produced in a flame burning carbon compounds. Like CGIs, FIDs sense hydrocarbon gases; FIDs measure target gas concentration using a detector installed in a measurement chamber through which gases of interest are continually drawn from the immediate surrounding atmosphere. Optical methane detectors may operate by absorption of infrared (IR) light by methane. Because natural gas consists primarily of methane, its detection serves to indicate the presence of natural gas. An optical methane detector may, for example, measure the attenuation of an IR light source passing through a gas sample at the methane-characteristic absorption wavelength to determine the presence of methane gas. Such a detector is more selective than either a CGI or a FID, because it measures methane specifically and not all combustible gases. A laser methane detector operates on the same absorption spectroscopy principle as an optical methane detector but uses a tunable wavelength-modulated diode laser as a light source. By sweeping the laser wavelength between a non-absorption band and a particular absorption band of a target gas molecule and monitoring the reflection measurements during the wavelength sweeps, both the background transmittance over the laser beam's path and the concentration of target gas molecules in the path can be accurately determined. Other gas sensors are based on electrochemical catalytic semiconductors, which have electrical properties that are altered in the presence of various hydrocarbon gases. These sensors are inexpensive, but may exhibit instability, drift, and false alarms due to moisture or household chemicals.

The hazard or condition sensed by sensor 230 is not critical to the invention. Sensor 230 may be configured to sense virtually any environmental or process conditions such as pressure, temperature, flow, fluid level, etc., or a security condition, e.g., access breaches, perimeter activity, etc.

Any suitable programming language may be used to implement without undue experimentation the functions of blocks 240, 250, 255 (see FIG. 2). Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript, for example. Further, it is not necessary that a single type of instruction or programming language be utilized in conjunction with the operation of the system and method of the invention. Rather, any number of different programming languages may be utilized as is necessary or desirable. With renewed reference to FIG. 1, the programming and/or device settings may be reconfigurable using a display 120. For example, display 120 may be a wireless tablet that enters the network 110 as a node and can communicate with any designated device—e.g., as in a LAN by broadcasting packets over the entire network 110 but designating a particular device as the proper recipient. A device 105 may enforce user privilege levels via a display 120, e.g., allowing users with supervisory privileges to change programming or device settings, and allowing other users merely to query the state of the device. A user with supervisory privileges may, for example, alter the alarm limits of a device (e.g., altering the sensor reading limits associated with a particular risk level) and may “force” designation of a different device as master device. In some embodiments a user may program or reprogram the device using a display 120.

A display may enforce a “silence” mode, suppressing message transmission by all devices in the network (the polling process in particular), in order to avoid interference with queries from a display or when a new configuration or programming is uploaded. Silence mode may also be employed when forcing designation of a new master (so that further elections do not occur until the newly designated master leaves the network) and when RF transmissions may pose a safety hazard.

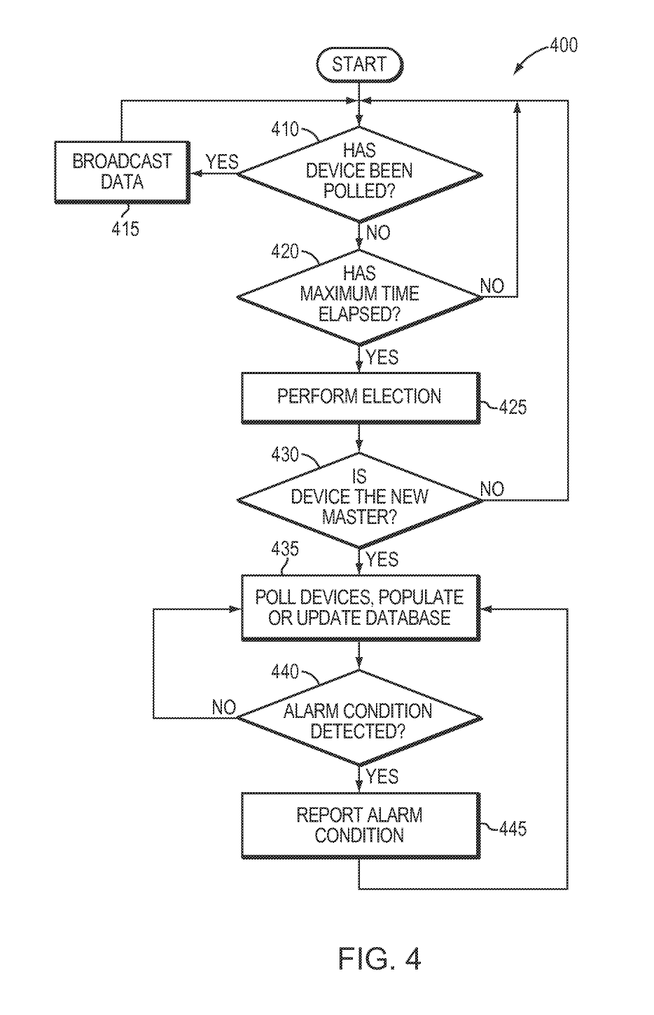

Operation of a particular device 120 is illustrated in FIG. 4. The illustrated method 400 begins with a polling step 410. When a device is polled, it broadcasts data over the network responsive to the query (step 415) for receipt by the querying device—typically the master device. If too much time elapses between polling transmissions (step 420), the device assumes that the master has exited the network. The amount of time is generally identical across devices and specified in each device's internal database (the “time before offline declaration” field); accordingly, all network-active devices will simultaneously conclude that a new master election (step 425) is required. The election protocol establishes which of the network-connected devices has the hierarchically most superior (e.g., greatest numerical) election priority parameter. In one embodiment, all devices multicast their election priority parameters (which may, again, simply be their numeric device identifiers) to all other devices, and each device recognizes the device with the highest-ranking parameter as the new master.

Unless the device recognizes itself as the new master in step 430, it behaves as a slave (i.e., executes the slave protocol 255). If the device has been elected as the new master, it executes the master protocol 250; for example, the master device may poll the other devices (step 435) to populate or verify its database 245 so that it now contains current data from all devices (and in so doing, effectively acknowledges its role as master to all other devices). If polling (or the state of the device's own sensor) reveals an alarm condition at one of the devices (step 440), the device reports the alarm condition (step 445). Reporting can take any desired form, and in fact, the form of reporting can be situation-dependent: for example, an alarm condition based on a sensor reading qualifying as a “high” risk level may require more urgent action than sensor reading corresponding to a lower risk level. Whereas a moderate risk may trigger broadcast of a message to the network, which will be visible to any connected display, a higher risk may cause the master device to issue a visual and/or audible alarm, or to communicate directly with an operator, e.g., by e-mail, text message, automated telephone call, etc. Alarm levels and corresponding actions to be taken by any device may be stored as parameter values in database 245, and instructions for executing these actions are contained in the master device protocol 250 and/or slave device protocol 255.

In some implementations, the network contains network subgroups—i.e., clusters of devices within the network. These clusters may be defined, for example, by proximity (e.g., groups of devices that can communicate directly without hops), functionally (by type of sensor or hazard sensed), by the type of location (e.g., high-traffic areas vs. areas typically inaccessible to people), etc. In such cases, a master device may be designated for each subgroup. As used herein, the term “network” is used generically to connote the entire network or a subgroup thereof.

As explained above, the network 110 is “self-healing” in that addition or departure of a device does not affect network operation. Entry of a new device may or may not, depending on the implementation, trigger a new election. In some embodiments, the master device reports its election priority when it polls the other devices; in this way, when a new device enters the network, it learns the master device's election priority and compares it to its own election priority. At this point, the entering device can (i) simply act as a slave until the current master device leaves the network, (ii) act as a slave if the election priority of the entering device is less than that of the current master device, or (iii) assert itself as the new master (e.g., by triggering the election protocol) within a network subgroup, or (iv) assert itself as the new network-wide master.

Although the foregoing discussion focused on a wireless implementation, wired network configurations are also possible and within the scope of the invention. For example, sensors may be wired in a network configuration using multiple distributed hubs and a network controller. Wired network configurations typically are not ad hoc, but within a wired network a single station may be designated as the “master” in terms of supervising and directing communication among stations, issuing queries and/or managing alarm conditions. In such configurations the role of the network controller is simply to maintain the network infrastructure at a hardware or administrative level, sensing the introduction of new nodes and registering a node's departure from the network. These conditions may be reported to the master node, which administers network-level functionality among nodes as described above. A multi-master protocol such as a controller area network (CAN) bus. In accordance with this protocol, the master outputs its priority at the start of every message. It monitors its own output to determine whether its transmissions properly appear on the bus. If not, it assumes that a master with a higher priority is transmitting, so the master with the lower priority ceases transmission. Accordingly, when a new device is added to a wired network, it can consider itself the master and start polling devices. If a higher-priority master already exists on the bus, the newly entering device will be “overruled” and become a slave.

Stations in a wired network may be connected point-to-point or in a loop. In the loop configuration, if the wires are cut in one location, the master will still have a connection to all the stations in the network. If the wiring is point-to-point and wires are cut, there will be some sensors the master cannot reach. In this case, the cut-off section of the network can elect a new master and continue to operate. As long as there an alarm station remains connected to the cut-off section, the system will continue to operate safely.

While particular embodiments of the invention have been illustrated and described in detail herein, it should be understood that various changes and modifications might be made to the invention without departing from the scope and intent of the invention. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A safety sensor and communication device for operation in conjunction with other safety sensor and communication devices in a network configuration, the device comprising:
a sensor for sensing a hazardous condition;
a transceiver for communicating over the network;
a controller operatively connected to the sensor and the transceiver;
a memory for storing (i) a unique device identifier and (ii) an alarm state having a value based on a state of the sensor; and
a database for storing network information;
wherein the controller is configured to (i) operate the device in a slave mode if a master device is detected on the network via the transceiver, (ii) detect departure of a master device from the network and cooperate with other devices on the network to designate a new master device, and (iii) operate the device in a master mode if the device is designated as the master device on the network,
and further wherein, when operating in the master mode, the controller is configured to communicate with other devices on the network and obtain sensor data therefrom, and to maintain the sensor data in the database.

2. The device of claim 1 wherein the controller, when operating in the master mode, is further configured to issue an alarm signal in response to sensing of the hazardous condition by one of the devices on the network.

3. The device of claim 1 wherein the controller is configured to (i) recognize the device as the new master device if the unique device identifier is hierarchically superior to the other identifiers stored in the database and (ii) broadcast to the network, via the transceiver, designation of the device as the new master device.

4. The device of claim 1 wherein, in the slave mode, the controller operates to (i) store a state of the sensor in the memory and (ii) respond to queries from the master device via the transceiver.

5. The device of claim 4 wherein, in the master mode, the controller is configured to query, via the transceiver, the memory of each other device connected to the network to determine the sensor state thereof and to issue an alarm signal if an alarm condition is detected.

6. The device of claim 1 wherein, in the master mode, the controller is configured to detect and communicate with, via the transceiver, a display device connected to the network.

7. The device of claim 1 wherein the sensor is a gas sensor.

8. The device of claim 1 wherein the transceiver is a wireless transceiver.

9. The device of claim 1 wherein the transceiver is a wired network interface.

10. A wirelessly linked network of safety sensors, the system comprising:
a plurality of safety-sensor devices each comprising a sensor for sensing a hazardous condition, a wireless transceiver, and a controller operatively connected to the sensor and the transceiver, the devices communicating wirelessly in a network configuration,
wherein each device is configured to sense departure of the master device from the network and, in response, to cooperate to designate as a new master device one of the devices still connected to the network.

11. The network of claim 10 further comprising at least one display wirelessly connectable to the network, the display, when connected, receiving data from a device operating as a master device, all devices other than the master device operating as slave devices being subject to query by the master device.

12. The network of claim 10 wherein the network configuration is a mesh network in which each device can communicate with every other connected device.

13. The network of claim 10 wherein each of the slave devices is configured to register an alarm condition sensed by the device's sensor but only the master device is configured to issue an alarm signal.

14. The network of claim 13 wherein the alarm condition comprises at least one of (i) a visual alarm, (ii) an audible alarm or (iii) an electronic communication with an operator.

15. The network of claim 14 wherein the visual alarm is communicated via a display.

16. The network of claim 14 wherein the audible alarm is communicated via a display.

17. The network of claim 10 further comprising the step of obtaining sensor data from at least some of the devices using the display.

18. The network of claim 17 wherein the sensor data is obtained by the display via the master device.

19. The network of claim 10 wherein:
each device is associated with a unique identifier;
the device identifiers form a hierarchy; and
the device associated with the identifier highest in the hierarchy is recognized as the new master device by the other devices.

20. The network of claim 10 wherein each slave device stores sensor data locally and communicates directly only with the master device.

21. The network of claim 10 wherein all device identifiers are stored on each of the devices.

22. The network of claim 10 wherein all device identifiers are stored only on the master device.

23. The network of claim 10 wherein each of the sensors comprises a gas sensor.

24. The network of claim 10 wherein the display is operable to change device settings of any of the devices.

25. The network of claim 10 wherein the display is operable to alter programming of any of the devices.

26. A method of sensing and communicating among a plurality of safety sensor devices in a network configuration, each device comprising a sensor for sensing a hazardous condition, the method comprising the steps of:
detecting, at each device, whether the hazardous condition is present;
operating the devices to cooperatively designate one of the devices as a master device, the other devices operating as slave devices;
causing the master device to (i) determine whether its sensor detects the hazardous condition, (ii) query each slave device for the hazardous condition, and (iii) monitor issuance of an alarm signal if the hazardous condition is detected at any device; and
sensing, by each device, departure of the master device from the network and, in response, cooperating with the other devices in an election procedure to designate as a new master device one of the devices connected to the network.

27. The method of claim 26 wherein the network configuration is a mesh network in which each device can communicate with every other device.

28. The method of claim 26 wherein the alarm signal comprises at least one of (i) a visual alarm, (ii) an audible alarm or (iii) an electronic communication with an operator.

29. The method of claim 28 further comprising the step of connecting at least one display to the network, the display receiving data from the master device.

30. The method of claim 29 wherein the visual alarm is communicated via the display.

31. The method of claim 29 wherein the audible alarm is communicated via the display.

32. The method of claim 29 further comprising the step of obtaining sensor data from at least some of the devices using the display.

33. The method of claim 32 wherein the display obtains the sensor data via the master device.

34. The method of claim 26 wherein:
each device has a unique identifier;
the device identifiers form a hierarchy; and
the election procedure comprises recognizing, by all of the devices, the device having the identifier highest in the hierarchy as the new master device.

35. The method of claim 26 wherein each slave device stores sensor data locally and communicates directly only with the master device.

36. The method of claim 34 further comprising adding a new device to the network and determining, without an election procedure, whether the added device has an identifier higher than the master device.

37. The method of claim 34 wherein, if the added device has an identifier higher than the master device, the master device thereafter operates as a slave device and the added device operates as the master device.

38. The method of claim 26 further comprising adding a new device to the network, the new device operating as a slave device at least until the master device departs the network.
